(19) United States
(12) Patent Application Publication
(10) Pub. No.: US 2017/0161780 A1
(43) Pub. Date: Jun. 8, 2017

(54) USING MICROPATTERNS TO MOTIVATE A CUSTOMER

(71) Applicant: Comenity LLC, Columbus, OH (US)

(72) Inventor: Benjamin M. MICHALEK, Columbus, OH (US)

(73) Assignee: Comenity LLC, Columbus, OH (US)

(21) Appl. No.: 15/043,055

(22) Filed: Feb. 12, 2016

Related U.S. Application Data
(60) Provisional application No. 62/263,417, filed on Dec. 4, 2015.

(51) Int. Cl. G06Q 30/02

(52) U.S. Cl. CPC G06Q 30/0252; G06Q 30/0259; G06Q 30/0261; G06Q 30/0267

(57) ABSTRACT

A method and system for using micropatterns to motivate a customer is disclosed. The technology determines that a triggering event is likely. In addition, a customer's location is also determined. A micropattern outlook for a customer's location is accessed. A time when there will be a forecast break in a micropattern is determined. A message is then provided to the customer to incentivize the customer, the message having a time window within the forecast break in the microsystem and an incentive for the customer, wherein the incentive is not related to the micropattern.

### CROSS-REFERENCE TO RELATED APPLICATIONS (PROVISIONAL)

This application claims priority to and benefit of co-pending U.S. Provisional Patent Application No. 62/263,417, filed on Dec. 4, 2015, entitled “USING MICROPATTERNS TO MOTIVATE SHOPPING AT A BRICK AND MORTAR STORE” by Benjamin M. Michalek, and assigned to the assignee of the present application, the disclosure of which is hereby incorporated by reference in its entirety.

### BACKGROUND

Presently, when the weather is poor, there can be a significant reduction in customers shopping. Poor weather or road conditions will cause a consumer to eat lunch at work, stay in the home instead of venturing out, and the like. For example, during the first quarter of the year, e.g., during the winter in the North East of the United States, it is quite common for brick and mortar stores to have significantly lower shopping traffic.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a customer motivation system, in accordance with an embodiment.

FIG. 2 is a flow chart of a method for using micropatterns to motivate shopping at a brick and mortar retail store, in accordance with an embodiment.

FIG. 3A is a block diagram of an incentive message indicator as viewed on a user's computing device, in accordance with an embodiment.

FIG. 3B is a block diagram of an incentive message as viewed on a user's computing device, in accordance with an embodiment.

FIG. 3C is a block diagram of an incentive message with reminder options as viewed on a user's computing device, in accordance with an embodiment.

FIG. 3D is a block diagram of an incentive message with share options as viewed on a user's computing device, in accordance with an embodiment.

FIG. 4 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview

Using micropatterns to motivate a user's behavior is discussed herein. In general, a micropattern is a subtle variable that influences someone's behavior. Examples of micropatterns can include traffic, weather, crime, shorter daylight, longer daylight, time of years, peak days, etc. For example, in the northern hemisphere, Q1 and early Q2 sales are often affected by winter weather patterns. Rain, snow and ice will keep kids and their care provider's home from school, and workers in their office instead of heading out for a lunch time or after work shopping trip. Similarly, traffic patterns such as traffic issues like delays and road construction can also keep a shopper from venturing out for a quick shopping trip. Shorter and longer daylight hours can also affect a shopper's behavior. For example, when it is dark out, there may be less motivation for a person to go shopping.

In one embodiment, the user's behavior being motivated is a customer's shopping behavior. However, the user's behavior being motivated may also include, sharing on social media, opening of a credit account, or the like. Moreover, the motivation may be provided to customers that use a retail store's application or have opted in to the store's offers.

For example, embodiments disclosed herein, provide a method and system for using micropatterns to motivate shopping is disclosed. The technology determines that a triggering event is likely. In addition, a customer's location is also determined. A micropattern outlook for a customer's location is accessed. A time when there will be a forecast break in a micropattern is determined. A message is then provided to the customer to incentivize the customer, the message having a time window within the forecast break in the microsystem and an incentive for the customer, wherein the incentive is not related to the micropattern.

In one embodiment, the technology allows a store experiencing a shopping lull due to weather, traffic, crime or the like to provide location based forecasts to customers that use a retail store's application or have opted in to the store's offers. For example, a micropattern(s) such as weather, traffic, daylight, and the like can be analyzed to determine when a conducing environment will occur. That is, the weather at a specific store or around a specific store can be analyzed for a clearing-up of the weather or traffic, a time period before the weather or traffic occurs, or the like. Although a shopping lull is described as one embodiment for initiating the customer motivation system, as described herein, there may be other triggering events such as, but not limited to, a temperature drop/rise of x degrees, micropatterns presently in the area, micropatterns forecast for the area, and the like.

For example, at a specific retail store there is presently a rainstorm and sales are down likely due to the rainstorm. However, the weather forecast provides a window of expected dry in the early afternoon. To motivate customers to shop at the brick and mortar store, the store would send a message with an incentive to a predefined number of customers. The incentive would not be based on the weather but instead would be based on getting customers to shop. That is, the incentive would not be for a raincoat on a rainy day or snow gloves on a snowy day. Instead, the incentive would be an offer such as 15% off on any item, or an event such as a BBQ, band, or other such entertainment. In another embodiment, instead of the store recognizing a slowdown in sales, historical information may be used to predict times of reduced sales and that forecast can be used to initiate the shopping motivation system.

The customer would receive an offer from the store that would include a time window and a weather/traffic break forecast for the time window. For example, today at 2 pm the sun is expected to come out, please come to our store between 2-4 pm and present this offer to receive 12% off of any purchase. In one embodiment, the offer would also be expanded if it was shared with a number of friends. For example, if you share this offer with 3 friends you will receive an additional 3% off. Moreover, in one embodiment, the offer will include a reminder function. For example, the customer could click on the reminder portion of the offer message and then a reminder would be set. The reminder offer could be a calendar, text, e-mail, social media reminder or the like.

By using the shopping motivation described herein, a brick and mortar store would benefit from increased traffic. That is, the message would drive traffic to stores with unique offers and the weather patterns to support the trip. In addition, the share with friends incentive would allow customers to enjoy shopping with friends and family and save more by doing so. Further, the message would provide an enhanced customer experience as it would allow the store to interact with customers in a relatable and meaningful way. That is, allowing a brand to empathize with customers through their environment.

It should be appreciated that the obtaining, accessing or contacting customers would conform to applicable privacy laws (e.g., federal privacy laws, state privacy laws, etc.).

### Operation

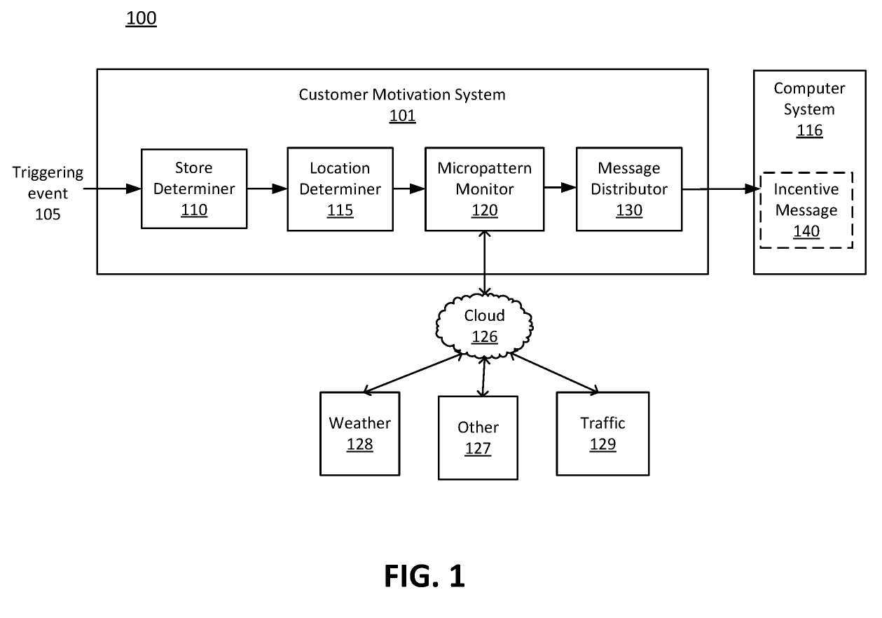

Referring now to FIG. 1, a block diagram 100 of a customer motivation system 101 is shown in accordance with an embodiment. In one embodiment, customer motivation system 101 receives triggering event 105 and provides an incentive message 140 that is received on a user's computer system 116.

For purposes of the following discussion, computer system 116 may be a desktop computer, a laptop computer, a mobile phone, a smart phone, a tablet, a smart watch, a piece of smart jewelry, smart glasses, or the like. In one embodiment, computer system 116 is capable of broadcasting and receiving via at least one network, such as, but not limited to, WiFi, Cellular, Bluetooth, NFC, and the like. In one embodiment, computer system 116 may have a positioning determining system. In another embodiment, computer system 116 may be able to determine location within a given radius, such as the broadcast range of a beacon, WiFi hotspot, overlapped area covered by a plurality of mobile telephone signal providers, or the like.

In one embodiment, customer motivation system 101 includes a store determiner 110, a location determiner 115, a micropattern monitor 120 and a message distributor 130. Although a number of applications and components are shown, it should be appreciated that there may be more of fewer components and applications within customer motivation system 101. Moreover, different pieces may be combined, re-organized, located separately from one another, or the like. The present structural breakdown is provided for purposes of clarity. For example, one or more of the components and applications may be found on one or more locations, such as, but not limited to a computer in the retail store, a server at a remote location, on the cloud 126 or the like.

In one embodiment, customer motivation system 101 receives triggering event 105. For example, triggering event 105 is data about sales for a specific retail store which includes location data for the retail store. In one embodiment, triggering event 105 is real-time or near-real time. In another example, triggering event 105 may be based on a daily tabulation, a few days' tabulation, a weekly tabulation or the like. In one embodiment, triggering event 105 may be, but is not limited to, a slowdown in sales, a temperature drop/rise of x degrees, micropatterns presently in the area, micropatterns forecast for the area, and the like. Moreover, historical information may be used to provide triggering event 105 to store determiner 110 of customer motivation system 101.

Store determiner 110 receives triggering event 105 and determines the location of areas or stores likely affected by triggering event 105. In one embodiment, the triggering event is occurring at a brick and mortar retail store.

In one embodiment, location determiner 115 determines that a location of a customer's computer system 116 is within a driving range of the brick and mortar retail store. In one embodiment, the computer system has an application for the brick and mortar retail store thereon. The location determination may be made by, but is not limited to: a location broadcast from computer system 116, a location broadcast from an app, such as a store's application, operating on computer system 116, and the like. Moreover, the location broadcast may be an actual location or a relative location broadcast. For example, if computer system 116 is equipped with a GPS, the location information may be specific lat and long. In contrast, if secondary location method such as signal triangulation, or the like is used, then the location of computer system 116 may be more generic. In another embodiment, the computer system 116 location may be determined from customer information such as a provided home address, work address, or the like.

In one embodiment, location determiner 115 will interact with computer system 116 to determine the location thereof. For example, location determiner 115 would be capable of broadcasting via at least one network, such as, but not limited to, WiFi, Cellular, Bluetooth, NFC, and the like.

Micropattern monitor 120 accesses a weather outlook for the location of the computer system 116 and determines if there is a weather system. In general, a weather system is inclement weather that is likely to be a cause for triggering event 105. Examples of a weather system include, but are not limited to, a snowstorm, a rainstorm, a thunderstorm, a tropical storm, a heat wave, or the like.

If a weather system is detected, micropattern monitor 120 will attempt to determine a time when there will be a forecast break in the weather system. For example, if there is a snowstorm, the weather forecast may call for a lull in the snow for a period of time. Similarly, if there is a rain or thunderstorm, the weather forecast may provide a window of reduced or stopped rain for a period of time. In one embodiment, to obtain the forecast, micropattern monitor 120 will use cloud 126 to access information about weather 128, traffic 129 or other micropatterns 127.

An example of cloud 126 is a network such as the Internet, local area network (LAN), wide area network (WAN), or the like. Weather 128 and traffic 129 are resources that provide location specific weather information and location specific traffic information respectively. Weather 128, traffic 129 or other micropatterns 127 may be a local resource, a virtual resource, an app on a user's computer system 116, a cloud based application or the like. For example, weather 128 is derived from one or more sources such as, but not limited to, Internet weather reports, pilot reports, social media, radio stations, news channels and the like. Similarly, traffic 129 is derived from one or more sources such as, but not limited to, map services, police blotters, road maintenance companies, state road departments, other driver's traffic reports, radio stations, news channels and the like. Moreover, other micropatterns 127 may include crime blotters, police reports, tide tables, daylight hours, time of year, predictions, forecasts, historical data and the like.

Message distributor 130 provides an incentive message 140 to computer system 116. In one embodiment, incentive message 140 is a push message. In one embodiment, incentive message 140 is delivered or broadcast to computer system 116 via a method such as, but not limited to, a beacon broadcast, WiFi broadcast, email, text message, SMS, social media alert, app alert, a notification from a store's application operating on the computer system, or the like. In one embodiment, message distributor 130 uses a push notification to provide the inventive message 140 to computer system 116. For example, the message distributor 130 provides incentive message 140 as a text message, an email, an SMS, a social media post to the user's social media, a telephone call, a message to an application operating on the computer system 116, or the like.

In one embodiment, message distributor 130 may also utilize retailer provided metrics to develop the offer. For example, the retail offer may include metrics or constraints such as custom text type, custom text verbiage, the size of the offer allocation and the like. In general, the size of the offer allocation refers to how many customers will be provided the incentive message 140, e.g., 1000, 10,000, 75, all, etc. In one embodiment, once the retailer metrics are established and the incentive message 140 scope is determined, message distribution 130 may allocate the offers all at once, or at a staggered timeline.

For example, if it is determined that the number of customers available to receive the incentive message 140 exceeds the size allocation for the message, message distributor 130 may selectively allocate the customers who will receive the incentive message 140. For example, if 5000 customers are determined to be available but the size of the offer allocation is 1500, then incentive message 140 will be sent to only 1500 customers. In one embodiment the customer determination may be random. In one embodiment, the customer determination may be based on a status such as VIP, gold member, patron, customer spending over a past period, or the like. Moreover, depending upon the shopping result from the initial incentive message 140, additional messages may be provided additional customers from the original customer pool. For example, if only 500 of the 1500 incentive message receiving customers utilized the incentive, customer motivation system 101 may provide the incentive message 140 to an additional 500 customers from the pool of 5000. Although the example has provided a few different values, it should be appreciated that the values are provided for purposes of clarity in the example.

In one embodiment, incentive message 140 includes, a time window within the forecast break in the weather system, a weather forecast describing the forecast break in the weather system, and an incentive to go to the brick and mortar retail store during the time window. For example, if the micropattern event is snow, incentive message 140 would include a coupon along with a message that says something like “Hey, there is snow coming to your area you have about 2 hours to get to the store and use the coupon.”

Although a number of items are discussed in incentive message 140, the contents of incentive message 140 may be adjusted, added to, or subtracted from by the retailer or by default. For example, in one embodiment incentive message 140 may not include a weather forecast or may include additional information about the retail store such as a new section, store hours, a contact number, a contact name, friends that are planning on taking part in the incentive, or the like.

In general, the time window is the window as discussed above, that is, the time period when a lull in the snow is expected, a time window when reduced or stopped rain is expected, a time when a break in a heatwave is forecast, a time window before the micropattern is expected to arrive, or the like. For example, the time window may be tomorrow from 12-2 pm; Thursday from 11-1 pm, Wednesday from 4-6 pm, etc.

In one embodiment, the weather forecast describing the forecast break in the weather system is a descriptor used to describe the weather change in the time window. For example, tomorrow from 12-2 pm there is expected to be a lull in the snow, Thursday from 11-1 pm a break in the rainstorm and partially sunny skies are expected, Wednesday from 4-6 pm a break in the heatwave is forecast, or the like.

The incentive may be a coupon, a percentage discount, an invitation to an event, or the like. Moreover, as previously discussed herein, the incentive is not weather related. In other words, the incentive would not be based on the weather but instead would be based on getting customers to shop. That is, the incentive would not be for a raincoat on a rainy day or snow gloves on a snowy day. Instead, the incentive would be an offer such as 15% off on any item, or an event such as a BBQ, band, or other such entertainment.

In one embodiment, instead of determining weather information, micropattern monitor 120 accesses a traffic outlook for the location of the computer system and determines that there is a traffic situation and when there will be a reduced traffic outlook. Message distributor 130 will then provide incentive message 140 that will include the time window, the information about the traffic, and the incentive.

In yet another embodiment, micropattern monitor 120 will access both the weather and the traffic to determine a time window that includes both weather and traffic requirements. Message distributor 130 will then provide incentive message 140 that will include the time window, the information about the traffic and the weather, and the incentive.

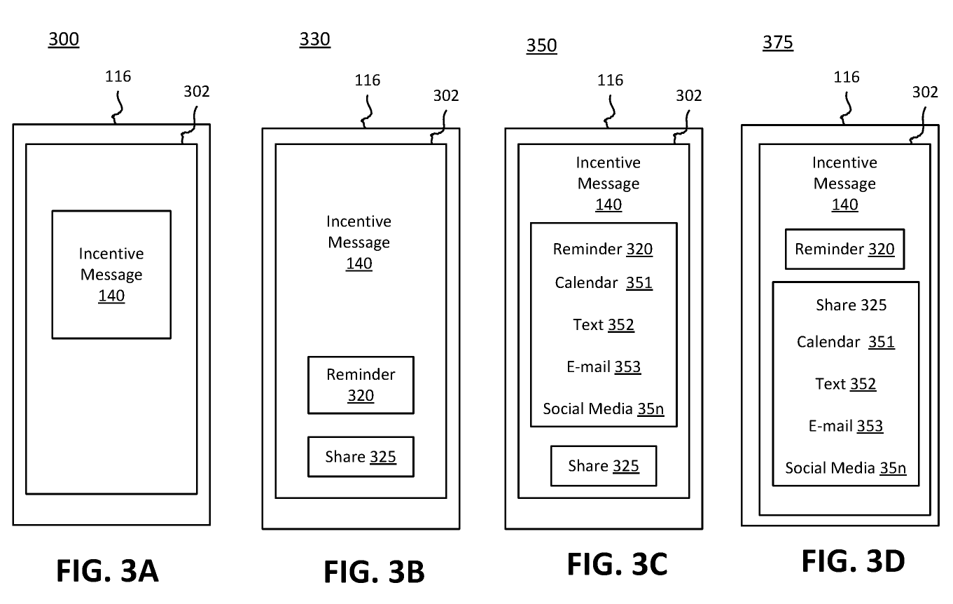

In one embodiment, incentive message 140 also includes an offer for an additional incentive when the incentive message is shared a predefined number of times, as shown in share 325 of FIGS. 3A-3D. Moreover, inventive message 140 may also include a selectable reminder 320 to provide a reminder of the time window, the incentive, and the brick and mortar retail store. Reminder 320 and share 325 are discussed in more detail herein in the discussion of FIGS. 3A-3D.

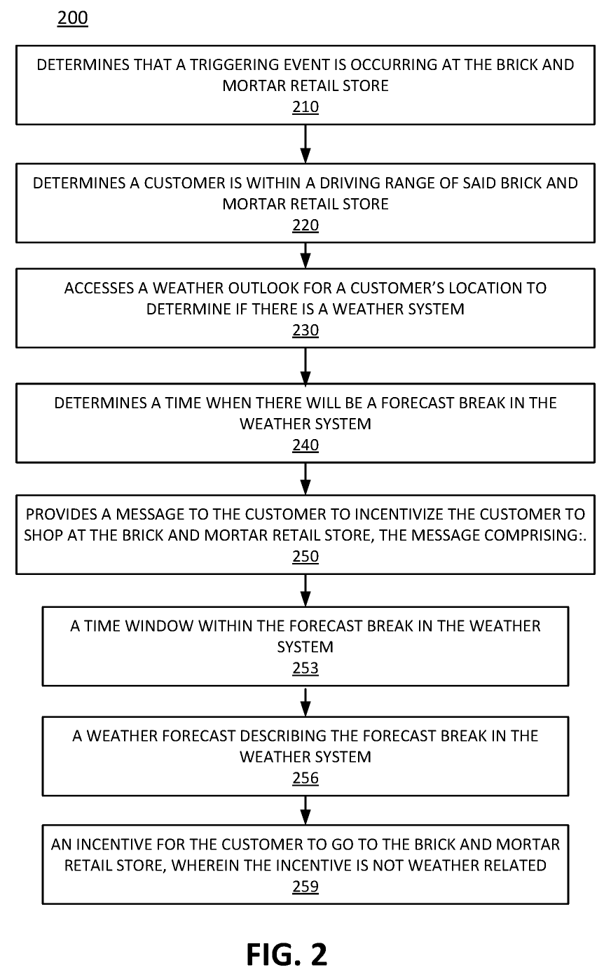

With reference now to FIG. 2, a flowchart 200 of a method for using micropatterns to motivate shopping at a brick and mortar retail store is shown in accordance with an embodiment.

Referring now to 210 of FIG. 2, one embodiment determines that a triggering event is occurring at the brick and mortar retail store.

With reference now to 220 of FIG. 2, one embodiment determines a customer is within a driving range of the brick and mortar retail store. For example, one embodiment utilizes an application on a customer's mobile device to determine a location of the customer. In another embodiment, a widget on a customer's computer is used to determine the location of the customer.

Referring now to 230 of FIG. 2, one embodiment accesses a weather outlook for a customer's location to determine if there is a weather system. For example, at a specific retail store there is presently be a rainstorm and sales are down due to the rainstorm.

With reference now to 240 of FIG. 2, one embodiment determines a time when there will be a forecast break in the weather system. For example, the weather forecast provides a window of expected dry in the early afternoon.

Referring now to 250 of FIG. 2, one embodiment provides a message to the customer to incentivize the customer to shop at the brick and mortar retail store, the message having one or more of the aspects described in 253, 256 and 259. The message being similar to incentive message 140 described herein. For example, one embodiment provides the message to the customer via the application on the customer's mobile device. Another embodiment provides the message to the customer via the widget on the customer's computer.

Referring now to 253 of FIG. 2, in one embodiment the message has a time window within the forecast break in the weather system. For example, the time window may be tomorrow from 12-2 pm; Thursday from 11-1 pm, Wednesday from 4-6 pm, etc.

Referring now to 256 of FIG. 2, in one embodiment the message has a weather forecast describing the forecast break in the weather system. For example, tomorrow from 11-2 pm there is expected to be a lull in the snow, Thursday from 11-1 pm a break in the rainstorm and partially sunny skies are expected, Wednesday from 4-6 pm a break in the heatwave is forecast, or the like. In another example, if the micropattern event is snow, incentive message 140 would include a coupon along with a message that says something like “Hey, there is snow coming to your area you have about 2 hours to get to the store and use the coupon before the snow is expected to arrive.”

Referring now to 259 of FIG. 2, in one embodiment the message has an incentive for the customer to shop, wherein the incentive is not weather related. In other words, the incentive would not be based on the micropattern but instead would be based on getting customers to shop. That is, the incentive would not be for a raincoat on a rainy day or snow gloves on a snowy day. Instead, the incentive would be an offer such as 15% off on all purchases, or an event such as a comedian, or other such entertainment.

In one embodiment, the method additionally accesses a traffic outlook for the customer's location to determine a time when there will be a reduced traffic outlook. The time when there will be a reduced traffic outlook is matched with the time window within the forecast break in the weather. The time when there will be the reduced traffic outlook with is then added to the time window within the forecast break in the weather.

In one embodiment, included in the message to the customer is an offer for an additional incentive when the customer shares the message with a predefined number of people. For example, if the message is posted on your social media and liked by 10 people the customer will receive an additional 5% discount.

In one embodiment, included in the message to the customer is a selectable reminder for reminding the customer of one or more of, the time window, the incentive, and the brick and mortar retail store.

Referring now to FIG. 3A, a block diagram 300 of an incentive message 140 indicator as viewed on a user's computing device 116 is shown in accordance with an embodiment. As described herein, computer system 116 may be a desktop computer, a laptop computer, a mobile phone, a smart phone, a tablet, a smart watch, a piece of smart jewelry, smart glasses, or the like.

Moreover, although a number of different types of information are displayed on each of the screens 302 shown in FIGS. 3A-3D, it should be appreciated that the information displayed at any level may be different in type, organization, layout, or the like. The following layouts are provided merely for purposes of clarity.

In one embodiment, prior to receiving an incentive message 140, the customer must opt into receiving shopping incentives for a brick and mortar retail store. In one embodiment the message is received via push notification at the user's computer system 116. In one embodiment, if the user has a plurality of computer systems 116, the user will receive the message at a default computer system 116, at a user selected computer system 116, or at a number of the user's computer systems 116.

At diagram 300, an incentive message 140 indicator is shown on screen 302. In one embodiment, the incentive message 140 indicator shown at diagram 300 may be a pop-up or alert type of message. That is, all or a portion of the incentive message may be shown. For example, in diagram 300, the incentive message 140 indicator may appear as a pop-up alert with a portion of the message displayed, a box that alerts a user that a message has been received, from the variety of email or text message alerts that a user has set-up on their computer system or the like.

For example, if computer system 116 is a mobile device and incentive message 140 is provided through the retail application on the mobile device, the message may appear as an indicator that the user should select the message to have the message open in the application. In another example, if the incentive message is a text message, the user may have the computer system 116 set up to provide a sound and an overview when a text is received. As such, the incentive message 140 shown in diagram 300 would include a sound and an overview.

With reference now to FIG. 3B, a block diagram 330 of an incentive message 140 as viewed on a user's computing device 116 is shown in accordance with an embodiment. In general, after a user selects the incentive message 140 indicator of FIG. 3A, the incentive message 140 is accessed. For example, the email or text message is opened, the app is started and the incentive message 140 is shown, and the like.

As described herein, incentive message 140 may include, but is not limited to, a time window within the forecast break in the weather system, a weather forecast describing the forecast break in the weather system, and an incentive to go to the brick and mortar retail store during the time window. Thus, although a number of items are discussed in incentive message 140, the contents of incentive message 140 may be adjusted, added to, or subtracted from by the retailer or by default. For example, in one embodiment incentive message 140 may not include a weather forecast or may include additional information about the retail store such as a new section, store hours, a contact number, a contact name, friends that are planning on taking part in the incentive, or the like.

Diagram 330 includes reminder 320 and share 325. For example, reminder 320 is a user selectable portion that allows a user to set a reminder, such as, but not limited to, the time window, the incentive, and the brick and mortar retail store. Reminder 320 is shown and discussed in additional detail in FIG. 3C. In one embodiment, share 325 provides an additional incentive when the incentive message is shared a predefined number of times, as shown in share 325 of FIG. 3D.

Referring now to FIG. 3C, a block diagram 350 of an incentive message with reminder 320 options as viewed on a user's computing device 116 is shown in accordance with an embodiment. In general, reminder 320 is an option that allows a user to set a reminder about the incentive offer. The reminder 320 may be one or more of a time reminder, a location reminder, an incentive reminder, and the like. In one embodiment, the reminder 320 may include a user selectable option for how the reminder is set. For example, the reminder 320 may be put in a calendar 351 on one or more of user's computing devices. Similarly, the user may select to receive the reminder via text 352, email 353, social media 35n, or the like.

In one embodiment, the reminder is automatically set when the user accesses the message.

With reference now to FIG. 3D, a block diagram 375 of an incentive message with share 325 options as viewed on a user's computing device 116 is shown in accordance with an embodiment. In general, share 325 is an option that allows a user to share the incentive offer and may also provide an increase in the incentive is the offer is shared a predefined number of times. For example, share 325 may include an additional incentive such as an additional 5% discount if the offer is shared at least 4 times. In another embodiment, share 325 may include the additional incentive on an incremental basis.

For example, for every 5 people the offer is shared with, the user will receive an additional 2% sale price. In one embodiment, share 325 includes a user selectable option for how the incentive message is shared. For example, the incentive message 140 may share via calendar 351. Similarly, the user may select to share the inventive message 140 via text 352, email 353, social media 35n, or the like.

Thus, by using the shopping motivation described herein, a brick and mortar store would benefit from increased traffic. That is, the message would drive traffic to stores with unique offers and the weather patterns to support the trip. In addition, the share with friends' incentive would allow customers to enjoy shopping with friends and family and save more by doing so. Further, the message would provide an enhanced customer experience as it would allow the store to interact with customers in a relatable and meaningful way. That is, allowing a brand to empathize with customers through their environment.

### Example Computer System Environment

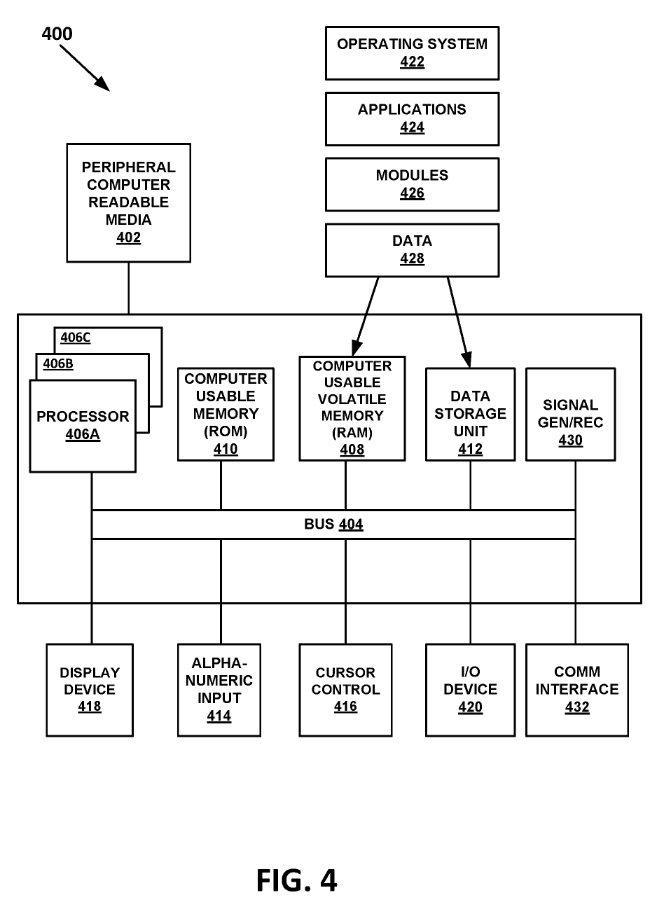

With reference now to FIG. 4, portions of the technology for providing a communication composed of computer-readable and computer-executable instructions that reside, for example, in non-transitory computer-readable storage media of a computer system. That is, FIG. 4 illustrates one example of a type of computer that can be used to implement embodiments of the present technology. FIG. 4 represents a system or components that may be used in conjunction with aspects of the present technology. In one embodiment, some or all of the components described herein may be combined with some or all of the components of FIG. 4 to practice the present technology.

FIG. 4 illustrates an example computer system 400 used in accordance with embodiments of the present technology. It is appreciated that system 400 of FIG. 4 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 4, computer system 400 of FIG. 4 is well adapted to having peripheral computer readable media 402 such as, for example, a disk drive, a compact disc, a flash drive, and the like coupled thereto.

Computer system 400 of FIG. 4 includes an address/data/control bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. Computer system 400 also includes data storage features such as a computer usable volatile memory 408, e.g., random access memory (RAM), coupled to bus 404 for storing information and instructions for processors 406A, 406B, and 406C.

System 400 also includes computer usable non-volatile memory 410, e.g., read only memory (ROM), coupled to bus 404 for storing static information and instructions for processors 406A, 406B, and 406C. Also present in system 400 is a data storage unit 412 (e.g., a magnetic disk drive, optical disk drive, solid state drive (SSD), and the like) coupled to bus 404 for storing information and instructions. Computer system 400 also includes an optional alpha-numeric input device 414 including alphanumeric and function keys coupled to bus 404 for communicating information and command selections to processor 406A or processors 406A, 406B, and 406C. Computer system 400 also includes an optional cursor control device 416 coupled to bus 404 for communicating user input information and command selections to processor 406A or processors 406A, 406B, and 406C. Optional cursor control device may be a touch sensor, gesture recognition device, and the like. Computer system 400 of the present embodiment also includes an optional display device 418 coupled to bus 404 for displaying information.

Referring still to FIG. 4, optional display device 418 of FIG. 4 may be a liquid crystal device, cathode ray tube, OLED, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick, non-contact input, gesture recognition, voice commands, bio recognition, and the like. In addition, special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other means such as, for example, voice commands. Computer system 400 also includes an I/O device 420 for coupling system 400 with external entities. For example, in one embodiment, I/O device 420 is a modem for enabling wired or wireless communications between system 400 and an external network such as, but not limited to, the Internet or intranet. A more detailed discussion of the present technology is found below.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. The present technology may be applied to one or more elements of described system 400.

System 400 also includes one or more signal generating and receiving device(s) 430 coupled with bus 404 for enabling system 400 to interface with other electronic devices and computer systems. Signal generating and receiving device(s) 430 of the present embodiment may include wired serial adaptors, modems, and network adaptors, wireless modems, and wireless network adaptors, and other such communication technology. The signal generating and receiving device(s) 430 may work in conjunction with one or more communication interface(s) 432 for coupling information to and/or from system 400. Communication interface 432 may include a serial port, parallel port, Universal Serial Bus (USB), Ethernet port, Bluetooth, thunderbolt, near field communications port, WiFi, Cellular modem, or other input/output interface. Communication interface 432 may physically, electrically, optically, or wirelessly (e.g., via radio frequency) couple computer system 400 with another device, such as a mobile phone, radio, or computer system.

The computing system 400 is only one example of a suitable computing environment and is not intended to suggest any limitation as to the scope of use or functionality of the present technology. Neither should the computing environment be interpreted as having any dependency or requirement relating to any one or combination of components illustrated in the example computing system 400.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for using micropatterns to motivate shopping, the method comprising:
determining that a triggering event is occurring at a brick and mortar retail store;
determining a customer is within a driving range of said brick and mortar retail store;
accessing a weather outlook for a customer's location to determine if there is a weather system;
determining a time when there will be a forecast break in the weather system;
providing a message to the customer to incentivize the customer to shop at the brick and mortar retail store, the message comprising:
a time window within the forecast break in the weather system;
a weather forecast describing the forecast break in the weather system; and
an incentive for the customer to go to the brick and mortar retail store, wherein the incentive is not weather related.

2. The method of claim 1 further comprising:
utilizing an application on a customer's mobile device to determine a location of the customer; and
providing the message to the customer via the application.

3. The method of claim 1 further comprising:
utilizing a widget on a customer's computer to determine a location of the customer; and
providing the message to the customer via the widget.

4. The method of claim 1 further comprising:
accessing a traffic outlook for the customer's location;
determining a time when there will be a reduced traffic outlook;
matching the time when there will be a reduced traffic outlook with the time window within the forecast break in the weather; and
providing the message to the customer to incentivize the customer to visit the brick and mortar retail store, the message comprising:
the time when there will be the reduced traffic outlook with the time window within the forecast break in the weather.

5. The method of claim 1 further comprising:
providing in the message to the customer an offer for an additional incentive when the customer shares the message with a predefined number of people.

6. The method of claim 1 further comprising:
providing in the message to the customer a selectable reminder for reminding the customer of the time window, the incentive, and the brick and mortar retail store.

7. The method of claim 1 wherein the incentive is selected from the group consisting of:
a percentage discount, and an event at the brick and mortar retail store.

8. A customer motivation system comprising:
a sales determiner to determine that a sales slump is occurring at a brick and mortar retail store;
a location determiner to determine a location of a customer's computer system within a driving range of said brick and mortar retail store;
a micropattern monitor to access a weather outlook for the location of the computer system and determine if there is a weather system and if so, a time when there will be a forecast break in the weather system; and
a message distributor to provide an incentive message to the computer system, the incentive message comprising:
a time window within the forecast break in the weather system;
a weather forecast describing the forecast break in the weather system; and
an incentive to go to the brick and mortar retail store during the time window, wherein the incentive is not weather related.

9. The system of claim 8 wherein the location determiner determines the location of the computer system via the group consisting of: a location provided by the computer system, and a location provided by an application operating on the computer system.

10. The system of claim 8 wherein the message distributor provides the incentive message to an application operating on the computer system.

11. The system of claim 8 wherein the message distributor provides the incentive message as a text message received on said computer system.

12. The system of claim 8 wherein the message distributor provides the incentive message as an email received on said computer system.

13. The system of claim 8 wherein the micropattern monitor accesses a traffic outlook for the location of the computer system and determines a time within the forecast break in the weather system when there will be a reduced traffic outlook.

14. The system of claim 13 wherein the message distributor adds the reduced traffic outlook to the incentive message.

15. The system of claim 8 wherein the incentive message further comprises:
an offer for an additional incentive when the incentive message is shared a predefined number of times; and
a selectable reminder to provide a reminder of the time window, the incentive, and the brick and mortar retail store.

16. A method for receiving micropattern related shopping incentives for a brick and mortar retail store, the method comprising:
opting into receiving shopping incentives for a brick and mortar retail store;
receiving a message via a push notification at a user's computer system, the message comprising:
a description of a change in a micropattern;
a time window within which the change in the micropattern will occur; and
an incentive to shop at the brick and mortar retail store during the time window, wherein the incentive is not related to the micropattern or the change in the micropattern.

17. The method of claim 16 wherein the micropattern is selected from the group consisting of weather patterns, traffic patterns and weather and traffic patterns.

18. The method of claim 16 wherein the message is selected from the group consisting of: an email, a text, and a message from an application.

19. The method of claim 16 further comprising:
accessing a content of the message, wherein the accessing of the message automatically sets a reminder to redeem the incentive, the reminder comprising:
the time window for the incentive;
a description of the incentive; and
a location of the brick and mortar retail store.

20. The method of claim 16 wherein the message further comprises:
an offer for an additional incentive when the message is shared a predefined number of times.
